(19) United States
(12) Patent Application Publication
(10) Pub. No.: US 2014/0032223 A1
(43) Pub. Date: Jan. 30, 2014

(54) VOICE ACTIVATED PHARMACEUTICAL PROCESSING SYSTEM

(71) Applicant: Roderick Powe, Las Vegas, NV (US)

(72) Inventor: Roderick Powe, Las Vegas, NV (US)

(21) Appl. No.: 13/560,545

(22) Filed: Jul. 27, 2012

(51) Int. Cl. G10L 11/00; G06Q 50/22

(52) U.S. Cl. 704/275; 704/E11.001

(57) ABSTRACT

The embodiments disclosed herein relate to a system and method for processing a prescription through voice-activated commands. The system and method efficiently and effectively process the prescription so that a pharmacy may handle the increasing prescription processing demands.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The embodiments disclosed herein relate to a device for facilitating prescription processing.

Prescription drug use is on the rise in the United States. One study on the use of prescription drugs showed that the number of people with at least one prescription increased from 67% to 74% between 2000 and 2006. Moreover, with the growing baby boomer generation getting set to retire, prescription drug use is expected to rise as well. On Jan. 1, 2011, the 1^{st} wave of the baby boomers turned 65. Each day thereafter, 10,000 baby boomers will reach the age of 65. Each new baby boomer will also increase the percentage of use of prescription drugs. Accordingly, pharmacies are currently pressured to fill more prescriptions with less manpower and minimal errors.

Accordingly, there is a need in the art for an improved system to facilitate processing of prescriptions.

### BRIEF SUMMARY

The embodiments of the system and method disclosed herein address the needs discussed above, discussed below and those that are known in the art.

The system contemplates software either loaded on a personal computer or accessible in the cloud. The system may communicate with a pharmacist or other user (e.g., technician) through voice-activated commands. The system may receive the voice-activated commands through a microphone or a telephone handset. The system may prompt the user for information and direction by providing an audible prompt such as a voice prompt through speakers or a visual prompt such as on a display. The user may control the system with voice commands, and/or mouse or touch screen actions.

In relation to the voice-activated commands, the user may speak a command into a microphone. The system gathers the voice profile of the spoken command compares the spoken voice profile to a set of standard profiles of one or more predefined libraries relating to the command. The system may select the best matched selection and present the same to the user for confirmation. The system may also present a list of potential alternative matches which may be ranked based on other criteria. By way of example and not limitation, when conducting a prescriber search, if there are 2 or more prescribers whose standard voice profile match closely to the spoken voice profile, then the prescriber who is more closely located to the pharmacy may be ranked first.

The system may have a plurality of databases of predefined libraries of various commands. Depending on where the user is in the process of processing the prescription, one or more databases of predefined libraries of various commands may be accessible to the user, while the remaining databases are inaccessible. In this manner, the comparison between be spoken voice profile is with a small subset of one or more databases of predefined libraries of various commands. The spoken voice profile is not being compared to the English dictionary but a very limited set of standard voice profile. By way of example and not limitation, the predefined library may be of last and first names for patients that have previously filled a prescription at the pharmacy. As such, the predefined library of last and first names does not include all possible names but only the names of patients that have previously filled a prescription with the pharmacy. The same may be true for other data being searched during the process.

More particularly, a pharmaceutical processing system is disclosed. This system may comprise a computer with software loaded thereon for performing the following steps of receiving a first voice activated command from a user related to a pharmaceutical process; comparing a first voice profile of the user's first voice activated command to standard voice profiles of a predefined library of pharmaceutical commands related to the pharmaceutical process; identifying one or more pharmaceutical commands from the library that matches the first voice profile of the user's first voice activated command; transmitting an audible signal to the user or an electronic signal to a monitor associated with the one or more identified pharmaceutical commands; and receiving confirmation that one of the identified pharmaceutical commands is correct.

The library of pharmaceutical commands may be associated with a frequency. The system may serve up a most frequently used pharmaceutical command from a set of identified pharmaceutical commands as an audible or visual signal to the user.

A set of pharmaceutical commands that matches the voice profile of the user's voice activated command may be displayed on the monitor as a list ranked from the most to the least used pharmaceutical command.

The most used pharmaceutical command may be displayed separately from the set of pharmaceutical commands.

The system may further comprise the step of receiving confirmation from the user that the identified voice activated command is correct.

The system may further comprise the steps of receiving a second voice activated command from the user related to the pharmaceutical process; after receiving the first and second voice activated commands from the user, comparing the first voice profile of the user's first voice activated command and a second voice profile of the user's second voice activated command to the standard voice profiles of the predefined library of pharmaceutical commands related to the pharmaceutical process; and identifying one or more pharmaceutical commands from the library that matches the first and second voice profiles of the user's first and second voice activated commands.

In the system, the receiving step may be accomplished with a clip-on microphone, free standing microphone, monitor microphone, or a headset microphone.

The system may be used to search for a patient, drug, or prescriber.

The predefined library of pharmaceutical commands may be a database of patient identification information, pharmaceutical information, directions for use information or prescriber information.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a pharmacist interacting with a system to process a prescription;

FIG. 2 is a schematic view of a cloud-based software with the system accessed by one or more pharmacies;

FIG. 3 is a flowchart for processing a prescription;

FIG. 4 is an illustration of the screen of the display shown in FIG. 1 showing a patient search screen;

FIG. 5 is a flowchart of a patient search;

FIG. 6 is a flowchart of a drug search;

FIG. 7 is a flowchart of a directions of use search;

FIG. 8 is a flowchart of a prescriber search;

FIG. 9 is a flowchart for entering a refill amount;

FIG. 10 is a flowchart for confirming the data obtained through the steps shown in FIGS. 3-9;

FIG. 11 is a flowchart from a system's perspective on processing a spoken voice command;

FIG. 12 is a database of drugs along with other correlated data;

FIG. 13 is a database of directions for use along with other correlated data;

FIG. 14 is a database of prescribers along with other correlated data;

FIG. 15 is a flowchart of a third-party search;

FIG. 16 is a flow chart of a drug interaction search;

FIG. 17 is a flowchart of the voice activated refill request;

FIG. 18 is a flowchart of a voice-activated prescription status inquiry;

FIG. 19 is a schematic for a prescription chip;

FIG. 20 is a flowchart for processing the prescription chip by a pharmacy; and

FIG. 21 is a flowchart for use of a health information chip.

### DETAILED DESCRIPTION

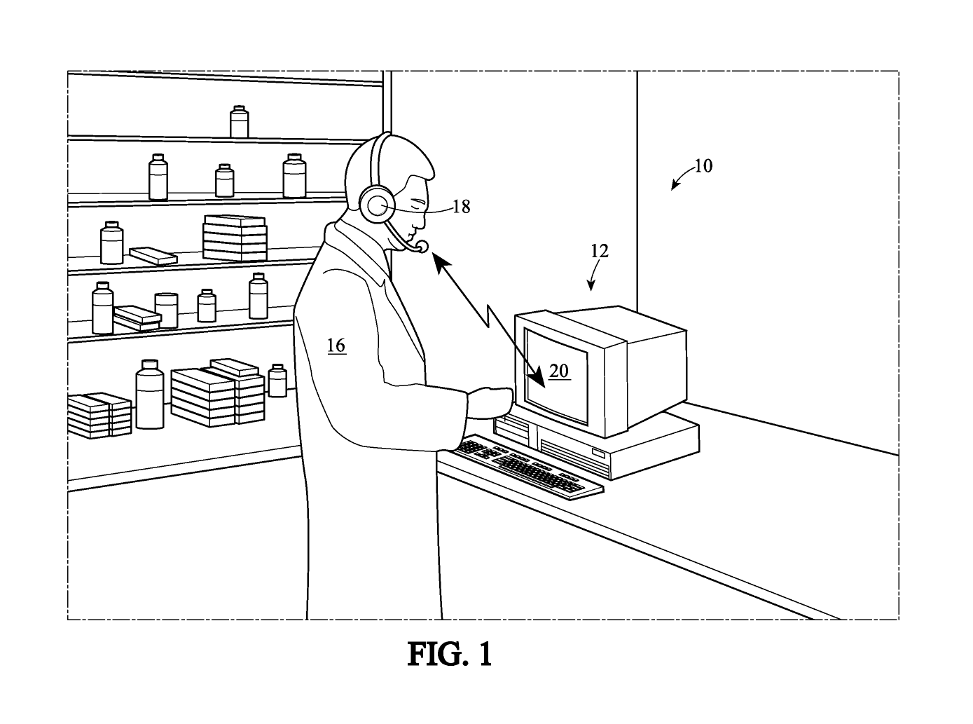

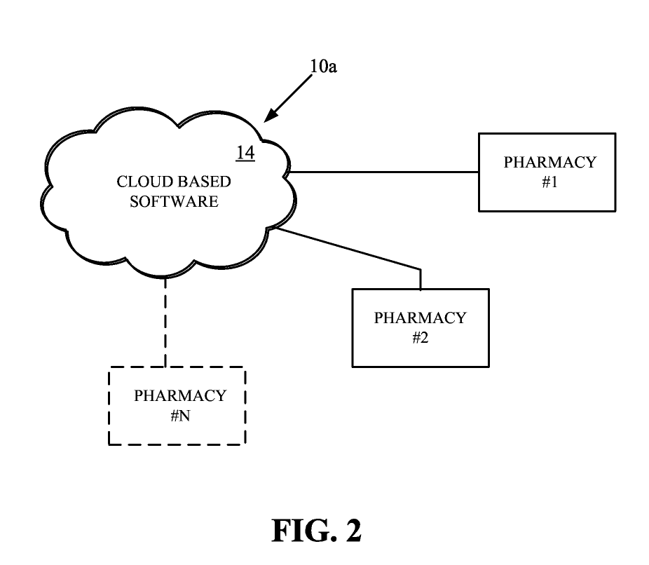

Referring now to the drawings, a voice activated pharmaceutical processing system 10, 10a is shown. The system 10, 10a may reside solely on a local computer 12 (see FIG. 1), in the internet cloud 14 (see FIG. 2) or as a combination thereof. The system 10, 10a assists a pharmacist 16 with various data entry and search functions in order to fill a prescription and/or other duties. The pharmacist 16 will interact with the system 10, 10a through the use of voice activated commands, keyboard strokes, mouse inputs and/or touch screen inputs to facilitate efficient and effective (i.e., reduce error) prescription processing. By way of example and not limitation, the pharmacist 16 may speak a voice command through the use of a microphone 18. The voice command is then processed by the system 10, 10a and the system 10, 10a provides feedback to the pharmacist 16 either audibly back through the headset 18 or via a monitor display 20. Based on the provided information from the system 10, 10a, the pharmacist 16 may confirm the data and/or select a different selection based on a list of possible alternatives provided by the system 10, 10a or manually enter and search the system 10, 10a for the correct information. By providing multiple ways of interacting with the system 10, 10a such as through voice activation, keyboard strokes, mouse inputs and/or touch screen displays 20, the system 10, 10a provides for a more efficient and effective prescription process so that the pharmacist 16 can process the ever increasing load due to the growing ageing population. The system 10, 10a may also include either a local computer 12 or internet cloud 14 or a separate stand alone program to assist pharmacists with the process of calling in to clear potential interactions with other pharmaceutical drugs. Additionally or alternatively, the system 10, 10a, may be set up for receiving outside calls from patients to assist them in the process of obtaining pharmaceuticals prescribed by their doctor.

The pharmacist 16, as used herein, may refer to a licensed pharmacist who is able to perform consultations regarding pharmaceutical use, a pharmaceutical technician, other pharmaceutical employees and any other individual that may be capable and authorized to conduct the data entry function of filling a prescription or other functions described herein.

Moreover, by placing the software program the cloud 14, multiple pharmacies can access the software program at their local store.

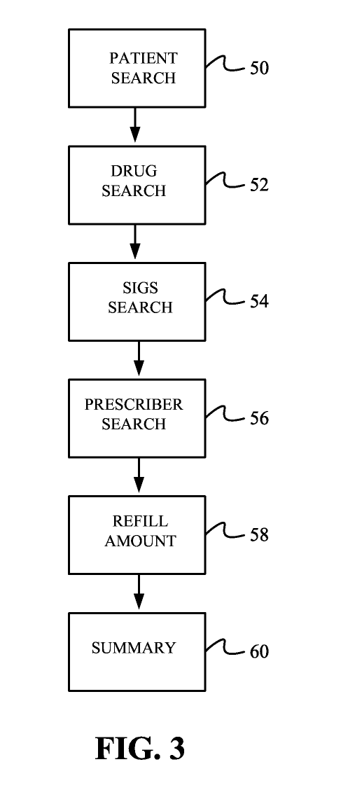

Referring now to FIG. 3, a flow chart for filling a new prescription is shown. In this flow chart, the steps of filling a prescription include conducting a patient search 50, conducting a drug search 52, conducting a SIGS (i.e., directions for use) search 54, conducting a prescriber search 56, entering a refill amount 58 and reviewing and confirming a summary 60 of the data that was entered during the patient search 50, drug search 52, SIGS search 54, prescriber search 56 and the refill amount 58. Each of these searches and functions: 50, 52, 54, 56, 58, 60 allow the system 10, 10a to facilitate effective and efficient data entry of the relevant prescription data.

To begin the process, the pharmacist 16 may speak a voice activated command into the microphone 18, which is then received by the system 10, 10a. At the start of a new prescription, the possible voice activated commands include “patient search”, “drug search”, “prescriber search”, “SIGS search” and “refill amount”. These possible voice activated commands are loaded into a predefined library of pharmaceutical commands. At the home screen (i.e., start of a new prescription), only these commands may be activated. Any other commands within other portions of the system 10, 10a are not available to the pharmacist 16 at this time. This greatly simplifies programming and speeds up the voice processing recognition by the system 10, 10a. In particular, each of these commands may have a standard voice profile associated therewith. As such, in the flow chart shown in FIG. 3, there are only six standard voice profiles, one for each of the commands: 50, 52, 54, 56, 58 and 60. When the pharmacist 16 speaks the voice activated command into the microphone 18, the system 10, 10a creates a voice profile of the spoken voice activated command and compares such voice profile to the standard voice profile in the available predefined library of start up commands (i.e., pharmaceutical commands). Since the system 10, 10a does not need to compare the voice profile of a pharmacist's 16 spoken command to a large set of possible words, the system 10, 10a can effectively and efficiently determine which one of the standard voice profiles in the predefined library of start up commands is being activated based on the voice profile of the pharmacist's 16 spoken command. By way of example and not limitation, the voice profile of the pharmacist's 16 spoken command may be compared to the standard voice profile based on the number of syllables, voice pitch and other identifying characteristics of the audible signal known in the art or developed in the future.

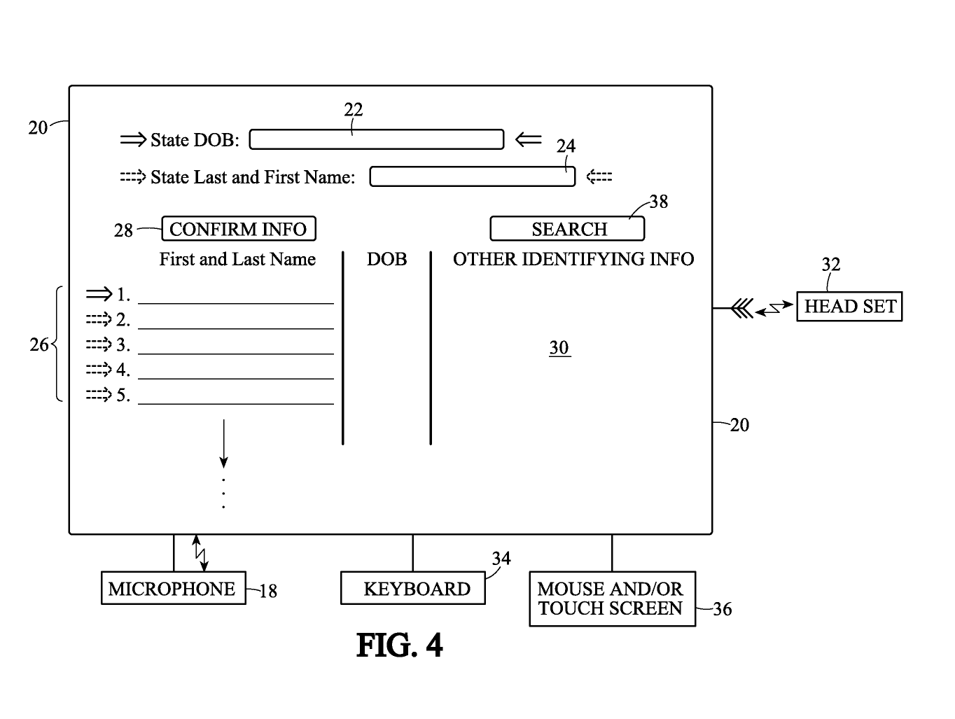

At the home screen, the pharmacist 16 will typically start with the first search, namely, the patient search 50. To do so, the pharmacist 16 will speak the phrase “patient search” into the microphone 18 at the home screen. The system 10, 10a processes such information and displays the patient search screen on the display 20 as shown in FIG. 4. The system 10, 10a prompts the pharmacist 16 with an audible sound to enter the patient's date of birth. The system 10, 10a may provide an audible voice through the headset 32 asking the pharmacist 16 to enter the patient's date of birth. Alternatively, the date of birth field 22 may be visually indicated either through highlighting or an arrow as shown in FIG. 4. The pharmacist 16 may speak into the microphone 18 and enter the patient's date of birth (e.g., enter patient's DOB). If the date of birth information provided by the system 10, 10a is correct, the pharmacist 16 can move on to the next information (last and first name) by speaking “next” or tabbing to the next input field with the keyboard. The system 10, 10a can prompt the pharmacist 16 to speak the patient's last and first name. The pharmacist 16 will speak the patient's last and first name using the microphone 18. The system 10, 10a receives the information as a voice profile and compares the pharmacist's 16 spoken command (i.e., last and first name) and compares the same with the standard voice profiles of last and first names of existing patients which then currently defines the available predefined library of voice activated commands. At the patient search screen, the voice commands of patient search 50, drug search 52, SIGS search 54, prescriber search 56, refill amount 58 and summary 60 are unavailable to the pharmacist 16. This limits the number of voice activated commands in the predefined library which is available to the pharmacist 16 at this step. This limitation provides a more efficient and effective processing of the spoken voice profile by the system 10, 10a. The system 10, 10a will display the date of birth and the patient's last and first name as well as other possible patients in the list 26. If the date of birth and last and first name of the patient in the date of birth field 22 and the last and first name field 24 are correct, then the pharmacist 16 can speak the words “confirm info” or click on the “confirm info” toggle button 28. If the “confirm info” command is spoken, the microphone 18 picks up the spoken command of the pharmacist 16 and processes the information. In the event that two patients have the same date of birth and last and first name, the date of birth field 22 and the last and first name field 24 would be left blank. In this case, only the list 26 would be populated along with other identifying information 30. The pharmacist 16 would then identify the correct patient in the system 10, 10a by speaking a number 1 through N to select a patient from the list 26 or by using the keyboard 34 up and down arrow keys to select the correct patient name. If the number is spoken into the microphone 18, then the display 20 will highlight the patient's information with either an arrow or a color. If there is only one patient that has the same DOB and last and first name, then the data can be displayed in the DOB field 22 and the last and first name field 24. The pharmacist 16 can speak the words “confirm info” which the system 10, 10a will recognize and use the selected patient in processing the prescription. Once the patient information is confirmed, the system 10, 10a may automatically proceed to the drug search step 52.

From the system's 10, 10a perspective, in the patient search 50, the system 10, 10a prompts the pharmacist 16 to enter the date of birth of the patient verbally. In particular, the system 10, 10a may audibly request the patient's date of birth through the speakers, preferably a headset 32 worn by the pharmacist 16 or technician. When the pharmacist 16 speaks the date of birth of the patient, the system 10, 10a creates a voice profile from the electronic data received by the microphone 18. The voice profile is then compared to a set of standard voice profiles from a predefined library of pharmaceutical commands relating to dates of birth. By way of example and not limitation, the predefined library of pharmaceutical commands for dates of birth may consist of the dates Jan. 1, 1900 through Dec. 31, 2050 or some other more suitable range. As such, by limiting the number of options, the accuracy and efficiency of the system 10, 10a is increased. The same process is also used for the last and first name of the patient in which the predefined library of pharmaceutical commands would include the current list of patients of the pharmacy. As such, the system 10, 10a will have a more effective and efficient means of comparing the voice profile of the spoken voice activated command and standard voice profiles within the predefined library of pharmaceutical commands (e.g., last and first names). By way of example and not limitation, when the pharmacist 16 states the patient's date of birth, the system 10, 10a may not be capable of deciphering the exact response spoken by the pharmacist 16 but when the pharmacist 16 speaks the patient's last and first name, the system 10, 10a may be capable of deciphering the correct patient based on the combination of the date of birth voice profile (i.e. pharmaceutical command) and the voice profile of the last and first name and comparing these profiles with the standard voice profiles within the predefined libraries of pharmaceutical commands relating to the date of birth and the last and first names of patients.

The system 10, 10a can communicate with the pharmacist 16 through the use of a headset 32 which may be connected to the system 10, 10a with a wire or wirelessly or visually through the display 20. The pharmacist 16 may communicate with the system 10, 10a in a variety of ways such as through the use of a voice command spoken through the microphone 18, keyboard commands through keyboard 34 or mouse and/or touch screen 36 inputs.

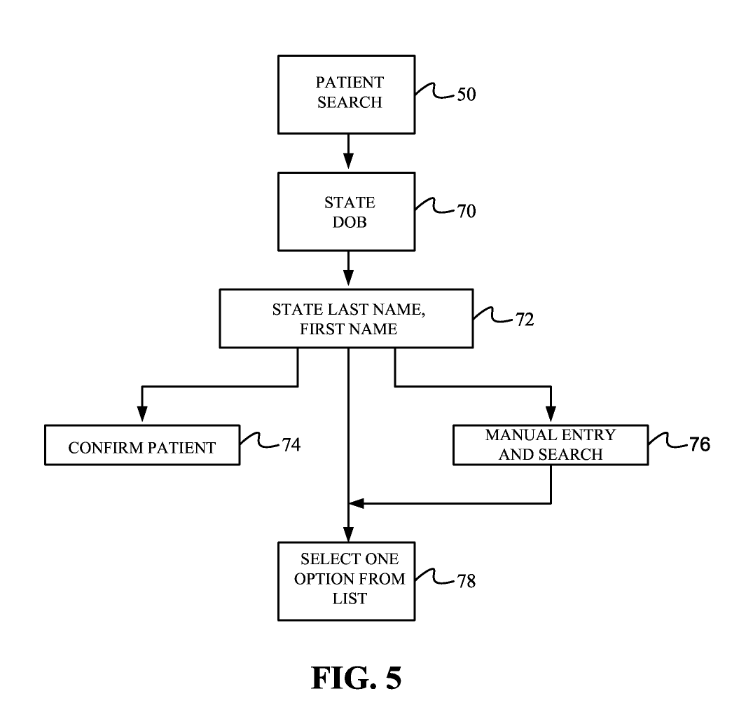

Referring now to FIG. 5, the patient search 50 step comprises the step of stating the date of birth of the patient 70, stating the last and first name of patient 72. Based on the output from the system 10, 10a either through the display 20 or the headset 32, the pharmacist 16 can confirm the patient 74 or make a manual entry and search 76 if none of the options in the list 26 are correct. After the search, the system 10, 10a may display a list 26 of possible patients from which the pharmacist 16 can select 78 one.

After the patient search 50 step, the system 10, 10a may prompt the pharmacist 16 to speak a voice activated command from a predefined library of voice activated commands consisting of patient search, drug search, SIGS search, prescriber search, refill amount and summary 50-60. Additionally or alternatively, the system 10, 10a may automatically enter the drug search step 52 without any further user intervention or input.

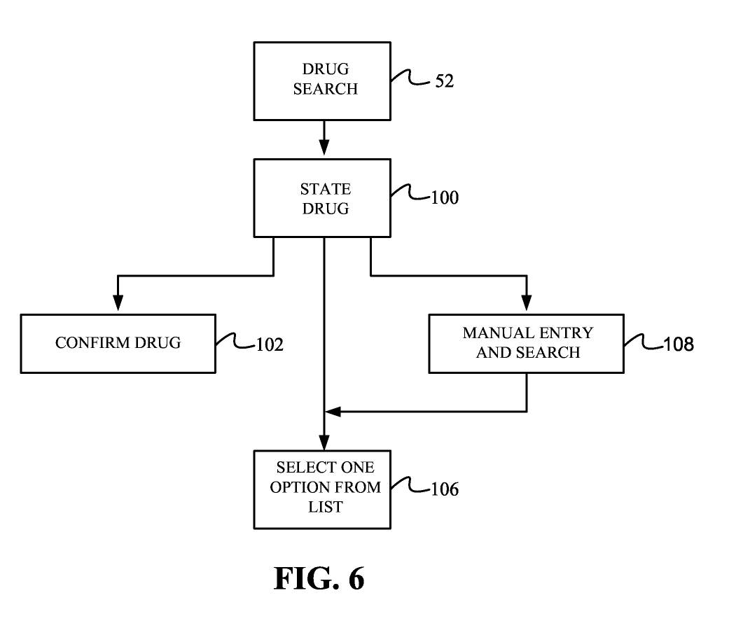

In the drug search step 52 (see FIG. 6), the system 10, 10a may prompt the pharmacist 16 to state a drug 100 either audibly through the headset 32 or by displaying a drug search 52 screen and displaying text to the effect of “state drug” with a blank input field. The pharmacist 16 can speak the name of the pharmaceutical drug into the microphone 18 at which time the system 10, 10a receives the electronic data and transforms it into a voice profile representing the pharmacist's 16 voice activated command. The system 10, 10a compares the voice profile of the pharmacist 16 voice activated command, which in this case is the name of the pharmaceutical drug to a set of standard voice profiles of a predefined library of pharmaceutical commands which in this case may be (1) a complete listing of available drugs in the market which are approved by the Federal Drug Administration, (2) a smaller subset of drugs that have been dispensed by the pharmacy or (3) a list of the x number of most popular drugs dispensed by the pharmacy (i.e., top 100 drugs dispensed by the pharmacy) or by some other metric. The system 10, 10a may display the pharmaceutical drug on the drug search 50 screen in the input field. Moreover, the system 10, 10a may produce an audible voice pronouncing the drug into the headset 32. If correct, the pharmacist 16 may confirm 102 the drug by toggling the “confirm info” button on the drug search 52 screen or by speaking “confirm info” into the microphone 18. If the drug selected by the system 10, 10a based on the comparison of the voice profile of the spoken pharmaceutical command by the pharmacist 16 and the voice profiles within the predefined library of pharmaceutical commands is incorrect, then the pharmacist 16 can select 106 one drug from a list 26 of potential drug matches by keying in the designated number of the appropriate drug from the list 26, speaking the number of the correct drug into the microphone 18 or using the mouse or the touch screen 36 to identify the correct drug. If the correct drug is not displayed in the list 26 on the display 20, then the pharmacist 16 may manually type in the correct drug and enter the drug search manually 108. The system 10, 10a will search the predefined library of pharmaceutical commands (i.e., list of pharmaceutical drugs) and display a list 26 of potential matches at which time the pharmacist 16 can select 106 one option from the list 26 either through the keyboard 34, speaking the command through the microphone 18 or utilizing the mouse or touch screen 36. If none of the options in the list 26 is correct, then the pharmacist 16 can manually enter the drug information in the drug input field using the keyboard 34 or speaking the drug name or spelling out the drug into the microphone 18 and toggling the search button 38. The system 10, 10a may receive the text name of the drug and search the predefined pharmaceutical voice activated commands and produce a list of possible drugs in list 26. The most common drugs may have a higher rank. If multiple drugs match the search criterion, the potential drug matches may be ordered based on frequency of prescription. In particular, those drugs which the pharmacy prescribes the most of either in dollar volume or number of prescriptions may have a higher rank. The pharmacist 16 can select 106 the drug from the list 26. The system 10, 10a may receive the drug based on the input from the pharmacist 16 and either prompts the pharmacist 16 for a voice activated command and/or automatically prompts the pharmacist 16 into the SIGS search 54 without any further intervention by the pharmacist 16.

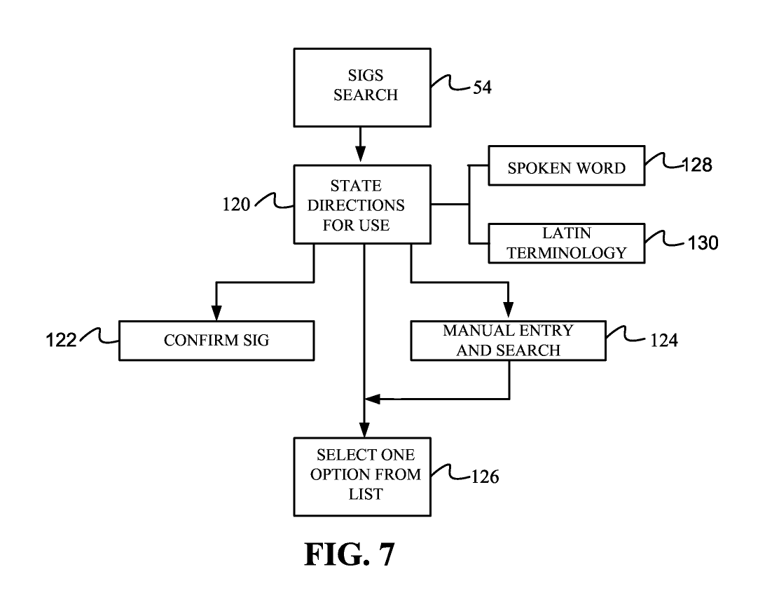

After the drug search 52, the system 10, 10a may proceed to the directions for use (i.e., SIGS) step 54, as shown in FIG. 7. The system 10, 10a may present the directions of use search screen on the display 20. Initially, the system 10, 10a may prompt the pharmacist 16 to state “directions for use” audibly through the headset 32 or visually through the monitor 20. The monitor 20 may display text with an input field for the direction for use. The pharmacist 16 can speak 120 the direction of use into the microphone 18 which is converted into a voice profile and compared to a set of standard voice profiles of a predefined library of directions of use. The best matching standard voice profile is displayed in the direction of use input field and the list 26 is populated with other possible matches for the directions of use. One possible arrangement in the list 26 provides for the more commonly used directions of use correlated to the selected drug and/or the commonly used directions for use correlated to the prescriber if the prescriber has already been determined.

If the correct directions for use are displayed in the directions for use input field, the pharmacist 16 may confirm 122 by speaking the command “confirm info” into the microphone 18 which will be recognized by the system 10, 10a, pressing “enter” via the keyboard 34, toggling the “confirm info” button 28 with the mouse and/or touch screen 36. If the incorrect directions for use are displayed in the directions for use input field, the pharmacist 16 may manually enter and search 124 the correct directions for use in the directions for use input field. The pharmacist 16 can speak 120 the words “confirm info” into the microphone 18 or toggle the “confirm info” button 28 to use the entered directions for use or speak the word “search” if the pharmacist 16 desires to search for matching directions for use in the predefined library of directions for use. If the “search” is conducted, the system 10, 10a may present possible alternatives in the list 26, one of which can be selected 126 by the pharmacist 16 by speaking the number through the microphone 18, entering in the appropriate number through the keyboard 34 or manipulating the mouse or touch screen 36.

The predefined library of directions for use may be related to spoken words 128 such as “take one capsule three times a day” or in the alternative, Latin terminology 130 such as “T.I.D”. After the correct directions for use are entered, the system 10, 10a may display the prescriber search screen on the display 20.

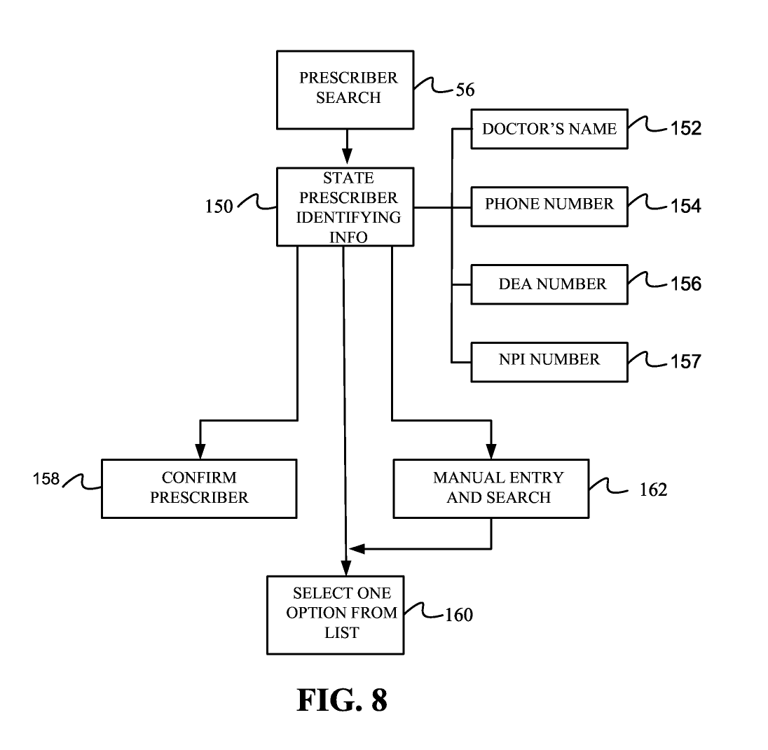

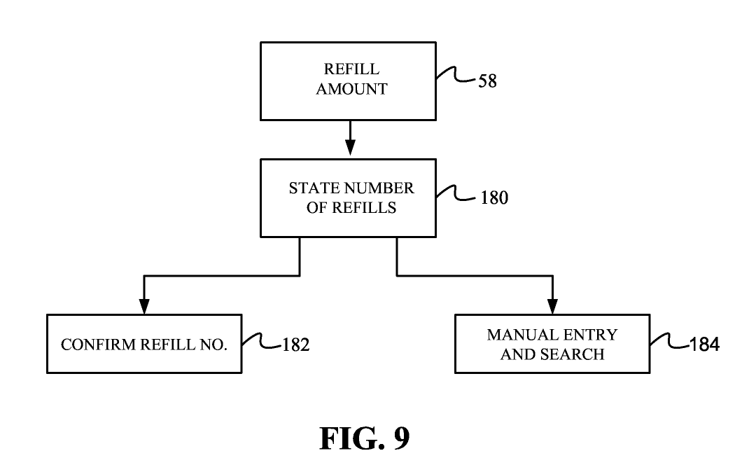

At the prescriber search screen 56, the system 10, 10a may prompt the pharmacist 16 to state the prescriber identifying information 150 such as the doctor name 152, phone number 154, drug enforcement agency number 156 and/or the national provider identifier (NPI) number 157. (see FIG. 8). As previously explained, the voice activated command of the pharmacist 16 spoken into the microphone 18 is converted into a voice profile which is compared to a set of standard voice profiles within a predefined library of prescriber identifying information which may be limited to a plurality of doctor names, phone numbers and drug enforcement agency numbers. The system 10, 10a may present the most likely prescriber in a prescriber input field and speak the prescriber's name through the headset 32. Additionally, the system 10, 10a may present alternative prescribers in the list 26. If the prescriber in the input field is correct, then the pharmacist 16 may speak the words “confirm info” 158 or toggle the “confirm info” button 28 to move to the next step in the process. The system 10, 10a saves the prescriber data and guides the pharmacist 16 through the prescription process shown in FIG. 3. If the correct prescriber is not in the prescriber input field, then the pharmacist 16 may select 160 one of the prescribers from the list 26 by speaking 158 the number associated with the correct prescriber, utilize the mouse and/or touch screen 36 to select the correct prescriber. If the correct prescriber is not in the list 26, the pharmacist 16 may manually enter 162 one of the prescriber's identifying information such as the doctor's name, phone number or drug enforcement agency number into the prescriber input field and speak the word search, or toggle the search button 38 through use the keyboard 34, mouse or touch screen 36 to start the search. The system 10, 10a may search its database and present a list of prescribers in the list 26. The pharmacist 16 can select 160 the correct prescriber by speaking the corresponding number into the microphone 18 or selecting the correct prescriber with the keyboard 34, mouse or touch screen 36.

After the correct prescriber is identified, the system 10, 10a may present the refill amount 58 steps on the screen 20 to the pharmacist 16 by displaying the same on the display 20. The system 10, 10a may prompt 180 the pharmacist 16 to enter in a number of refills into a number of refills input field by producing an audible sound through the headset 32 instructing the pharmacist 16 to enter such number and presenting the number of refills input field on the display 20. The pharmacist 16 can speak a number through the microphone 18. The system 10, 10a will attempt to recognize the number by comparing a voice profile of the spoken voice command to a set of standard voice profiles of a predefined library of numbers such as each number between 1 and N. The system 10, 10a will present the number in the number of refills input field and/or speak the number through the headset 32. The pharmacist 16 can confirm the number by speaking 182 the words “confirm info” into the microphone 18 or selecting the “confirm info” button 28 with the keyboard 34, mouse or touch screen 36. If the incorrect number is presented in the number of refills input field then the pharmacist 16 may enter 184 the correct number with the keyboard 34.

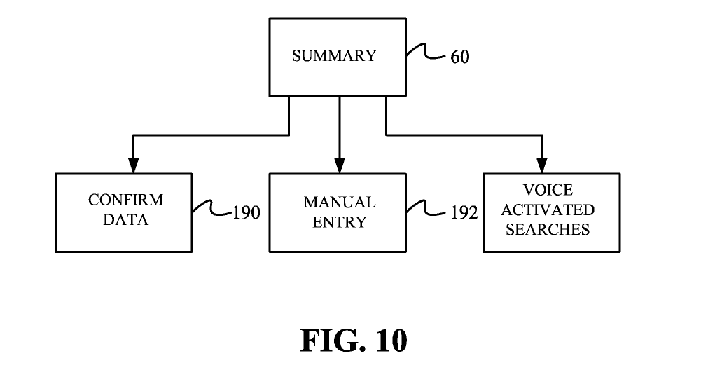

Upon confirmation of the refill number, the system 10, 10a may present the entered data relating to the patient, drug, directions for use, prescriber and refill number on one or more screens as a summary 60. (see FIG. 10). If the information is correct, the pharmacist 16 may speak 190 the words “confirm info” into the microphone 18 or select the “confirm info” button 28 with the keyboard 34, mouse or touch screen 36. If the information is incorrect, the pharmacist 16 may correct the information either by speaking the correct information into the microphone 18 or manually entering the correct information with the keyboard 34, mouse or touch screen 36. The pharmacist 16 may also redo one of the prior searches, namely, patient search 50, drug search 52, directions for use search 54, prescriber search 56 and refill amount 58. After conducting these searches, the system 10, 10a may present the summary 60 to the pharmacist 16 once again. If correct, at this time, the prescription filling process is completed and the prescription data is entered.

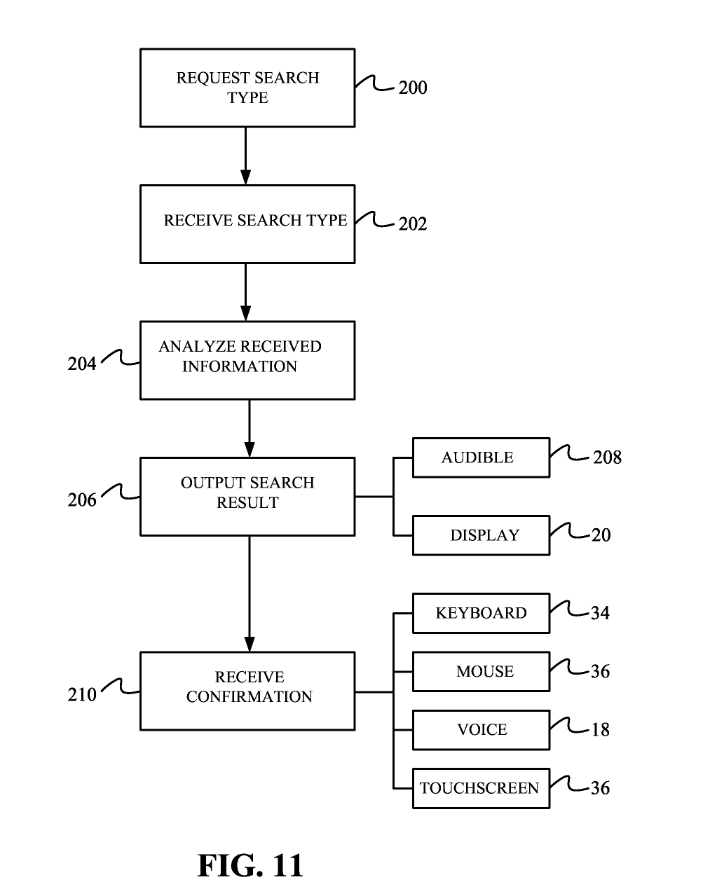

Referring now to FIG. 11, from the system's perspective, the system 10, 10a may request a search type 200 from the pharmacist 16 by producing an appropriate spoken command through the headset 32 or displaying text or other indicia on the display 20 related to the search type. The pharmacist 16 may enter the search type through one of the following methods, namely, spoken command, keyboard 34, mouse or touch screen 36. When the pharmacist 16 speaks a spoken command into the microphone 18, the system 10, 10a captures 202 the spoken command as a voice profile. The system 10, 10a receives the search type 202 from the pharmacist 16. The system 10, 10a may analyze 204 the voice profile of the spoken command by comparing the voice profile of the spoken command to a set of standard voice profiles of a predefined library related to the command. By way of example and not limitation, the predefined library may comprise the following information: range of calendar dates, last and first names, numbers such as 1-N, drug names, directions for use and prescribers.

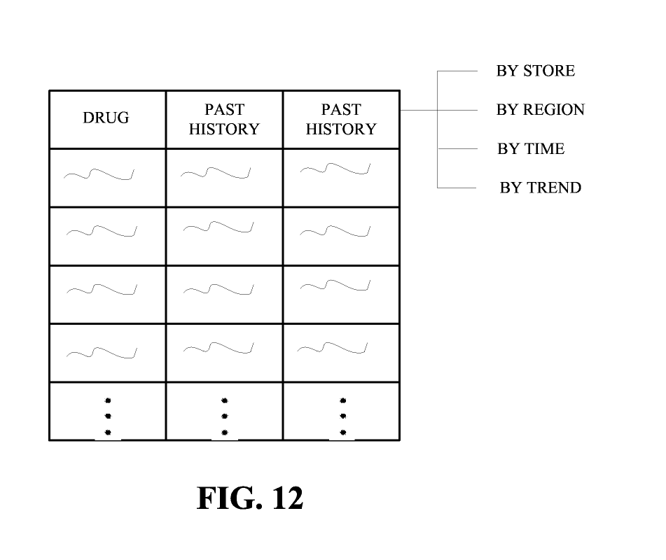

FIGS. 12-14 illustrate three different predefined libraries related to drug names, directions for use, and prescribers. The predefined library for the drug names include the voice profile for a drug name and other related drug information relating to a particular store, region, time or trend. In comparing the voice profile of the spoken command to the set of standard voice profiles for the predefined library of the command, the system 10, 10a will produce a list of possible matches. Depending on the frequency of the drug being dispensed through the pharmaceutical retail store or outlet, the system 10, 10a may present 206 the most popular dispensed drugs to the pharmacist 16 in the drug input field and/or present the possible matches in the list 26 in descending order with respect to frequency of prescription pertaining to the particular store. The selection can also be ordered by frequency relating to the region, time or trend in the past week, month or year or other time period.

The results of the analysis 204 may be presented to the pharmacist 16 audibly 208 through the display 20. If audibly 208, the best match may be spoken to the pharmacist 16 through the headset 32. If through the display 20, the best match may be presented to the pharmacist 16 separate and apart from the list 26 of possible matches. The system 10, 10a may receive confirmation 210 of the correct information via the keyboard 34, mouse or touch screen 36 or the microphone 18 via a spoken command.

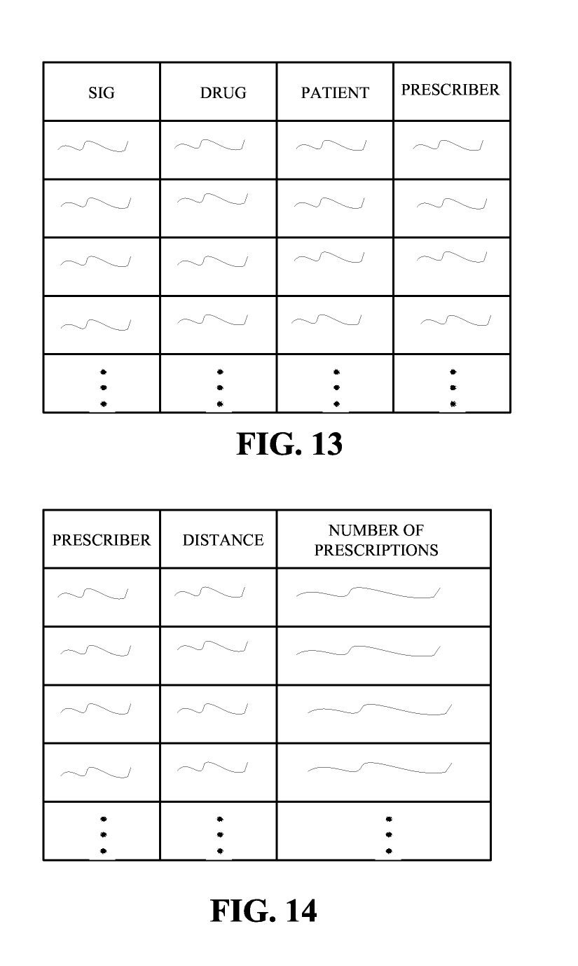

Referring now to FIG. 13, a predefined library for the directions for use (i.e., SIG) is shown. Particular directions for use may be correlated to the drug, patient or prescriber or other relevant data. When the pharmacist 16 speaks the directions for use, the system 10, 10a may match the voice profile of the spoken command to one of the standard voice profiles within the predefined library of directions for use based purely on a comparison there between. However, if the pharmacist 16 has already selected the drug name, patient and/or prescriber, the system 10, 10a may select the appropriate directions for use for the pharmacist 16 based on the other criterion in addition to the comparison between the spoken and standard voice profiles. Moreover, the system 10, 10a may present and organize the other probable matches higher up on the list 26 if more correlated information such as the drug name, patient and prescriber is entered and matched.

Referring now to FIG. 14, a predefined library of prescribers is shown. The prescribers in the predefined library are correlated to the distance to the pharmaceutical outlet such as the retail store and the number of prescriptions filled by the outlet and prescribed by the prescriber. In the prescriber search 56, the pharmacist 16 may speak the prescriber information. Other metrics are also correlated and may be associated with the prescriber. After comparing and analyzing voice profiles of the spoken prescriber and the standard voice profiles of prescribers in the predefined library, the system 10, 10a presents the most probable matches of prescribers higher up on the list based on the distance of the prescriber to the retail store outlet. By way of example and not limitation, prescribers located closer to the store outlet may be ranked higher up on the list 26. The closest prescriber may be presented in the prescriber input field and/or spoken to the pharmacist's 16 headset 32. Alternatively, the prescriber with the most number of prescriptions may be ranked higher up on the list 26.

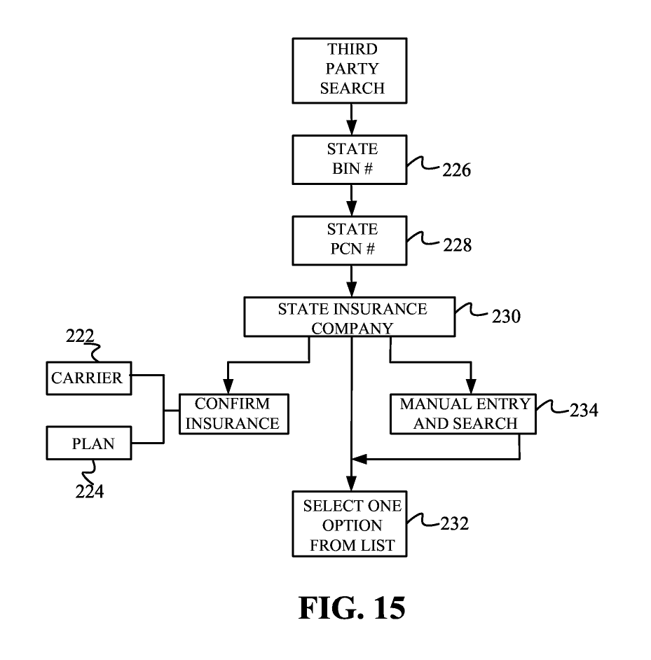

Referring now to FIG. 15, a third-party search 220 is contemplated. The third-party search 220 finds the insurance carrier 222 and particular plan 224 under which the prescription may be covered. To this end, the system 10, 10a may display a third-party search screen on the display 20. The third-party search screen may have three input fields, one for the BIN number 226, one for the PCN number 228 and one for the insurance company 230. Upon startup of the third-party search screen, the system 10, 10a may request the user for the BIN number 226, PCN number 228 and the insurance company 230 through the headset 32. The pharmacist 16 may speak the commands such as BIN number XXX, PCN number YYY and insurance company name XYZ into the microphone 18. The system 10, 10a may parse out the numbers XXX, YYY and the name XYZ to create corresponding voice profiles. In particular, the system 10, 10a may recognize the words “BIN number”, “PCN number” and “insurance company” name and extract the voice profiles for the information between these words, namely, XXX, YYY and XYZ. The predefined library for the third-party search may include standard voice profiles for XXX, YYY and XYZ which the system 10, 10a may compare to the voice profiles of the spoken commands. Based on the comparison, the system 10, 10a may present a list 26 with five columns including the BIN number, PCN number, insurance company name correlated to the carrier and plan. The pharmacist 16 may select 232 the carrier and plan by speaking the number associated with the carrier and plan through the microphone 18 or select the correct carrier plan with the keyboard 34, mouse or touch screen 36. If the correct carrier and plan is not shown in the list 26, the pharmacist 16 may enter the BIN number, PCN and the insurance company name directly into the respective input field with the keyboard 34. Thereafter, the pharmacist 16 may toggle the search button 28 with the keyboard 34, mouse or touch screen 36. This is a manual entry and search step 234. The system 10, 10a may list corresponding matches in the list 26. The pharmacist 16 may select 232 the correct carrier and plan from the list 26.

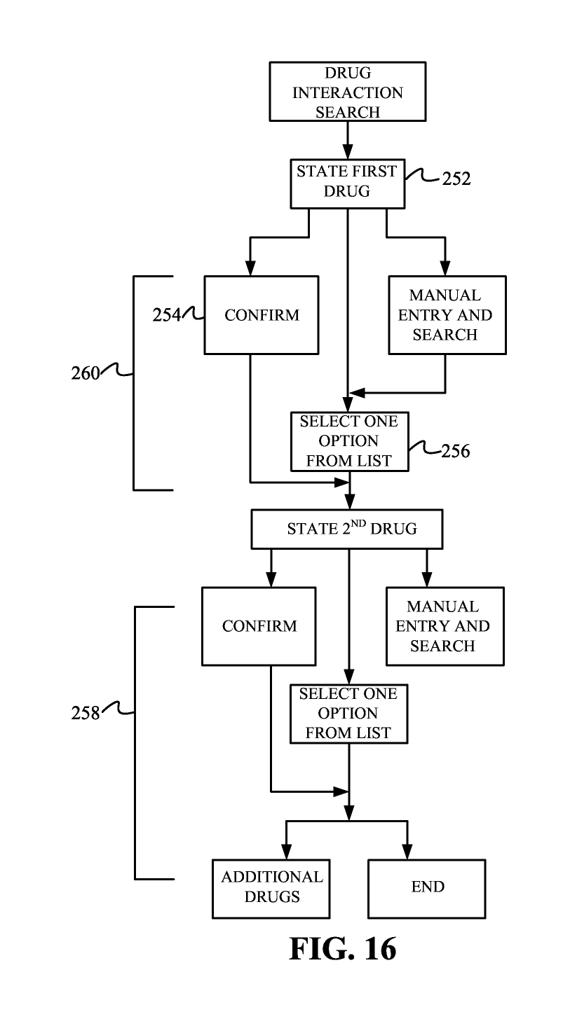

Referring now to FIG. 16, a drug interaction search step 250 is shown. The system 10, 10a will prompt the pharmacist 16 to search for the first drug through the use of headset 32 or display 20. The pharmacist 16 will state the first drug 52 into the microphone 18 at which time the system 10, 10a will receive such information, produce a voice profile and compare the spoken voice profile to the voice profiles within the predefined library of drugs. The system 10, 10a will speak the matched first drug to the pharmacist 16 through the headset 32 and also pre-populate a first drug input field as well as provide other alternative drugs in a list 26. If the system 10, 10a has correctly identified the first drug, the pharmacist 16 may confirm 254 the information by speaking “confirm info” into the microphone 18 or toggling the “confirm info” button with the keyboard 34, mouse or touch screen 36. If the system 10, 10a has incorrectly identified the drug, the pharmacist 16 may manually enter the drug and search 254 the system 10, 10a database. The system 10, 10a will present a list 26 of possible drugs. The pharmacist 16 may select one of the drugs from the list 26. The system 10, 10a will prompt the pharmacist 16 to state one or more additional drugs as shown in process 258 which follows the same format for the first drug 260. After all of the drugs have been entered, the system 10, 10a will check for any negative drug interactions between the first, second, N^{th} drugs which were previously entered. Such information will be presented to the pharmacist 16.

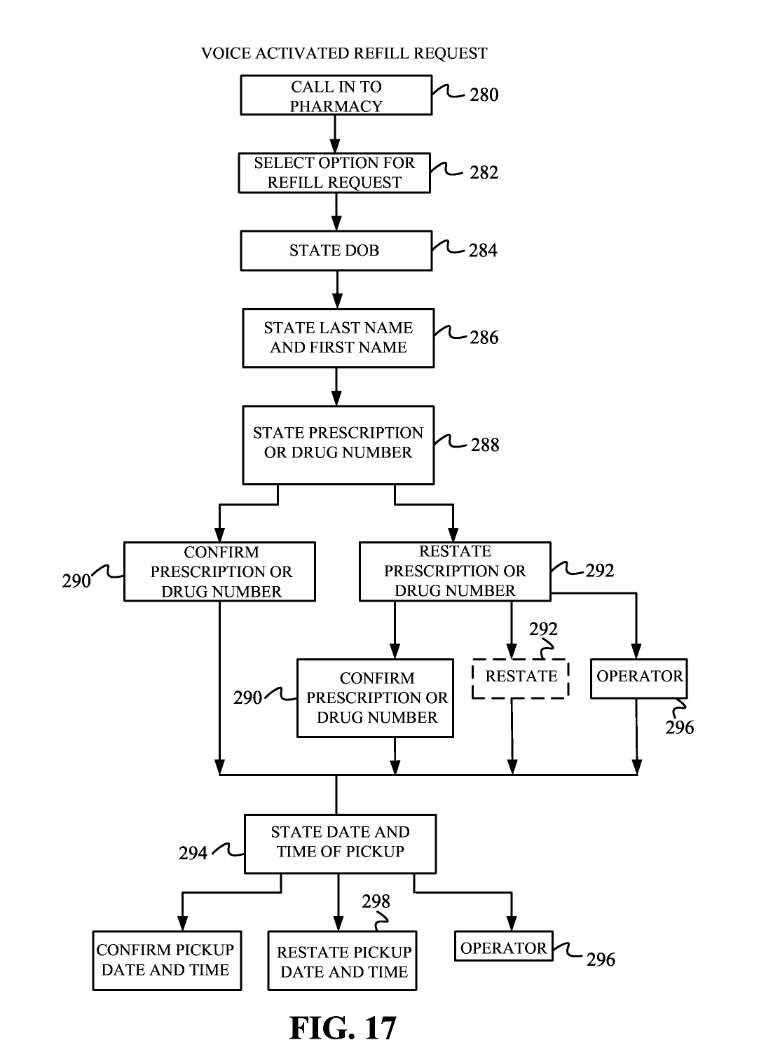

Referring now to FIG. 17, the system 10, 10a may also have a voice activated refill request component. This allows a patient 324 to call into a pharmacy 280. The system 10, 10a will provide a plurality of options, one of which will be an option for a refill request. The patient 324 can select 282 the option by pressing the corresponding number on the telephone keypad or speaking the option into the handset of the telephone. The system 10, 10a can then prompt the user to state his or her date of birth. The user can enter 284 his or her date of birth either with the use of a telephone keypad or by directly speaking the command through the handset. The system 10, 10a may then prompt the user to state his or her last and first name at which time the user may speak 286 his or her last and first name into the telephone handset. The system 10, 10a may then prompt the user to state the prescription or drug number at which time the user may speak 288 such information into the telephone handset. As the user is speaking the relevant information into the telephone handset or entering the information through the telephone keypad, the system 10, 10a receives the information and transforms the spoken command into a voice profile which is compared to a set of standard voice profiles of the predefined libraries of date of births, last and first names and prescription drug numbers.

The voice profiles for the date of birth, last and first names and prescription or drug numbers may be compared to standard voice profiles sequentially. By way of example and not limitation, the voice profile for the spoken date of birth may be compared to the standard voice profile for range of dates of birth, then the last and first names and then the prescription or drug numbers. Alternatively, the voice profiles for the date of birth, last and first names and prescription or drug numbers may be compared to standard voice profiles during one step after the user speaks the date of birth, last and first names and the prescription drug numbers. Based on the above comparison, the system 10, 10a may select the most probable prescription or drug number.

The system 10, 10a may speak the prescription or drug number back to the user through the telephone handset. If correct, the user may confirm 290 the prescription or drug number by pressing an appropriate number on the keypad or speaking “yes”, “confirm” or other words of affirmation. If the prescription or drug number is incorrect, the system 10, 10a may prompt the user to restate the prescription or drug number at which time the user may do so 292. The system 10, 10a may state a new prescription or drug number which the user may confirm or reject. If the number is still incorrect, the user may restate the prescription or drug number or ask for an operator 296. Once the correct prescription or drug number is confirmed, the system 10, 10a may state 294 the date and time of pickup to the user. The user may confirm 296 that the stated date and time of pickup are acceptable. If unacceptable, the user may request an earlier pickup date and time. The system 10, 10a will restate 298 an earlier time which the user may confirm or reject or in the alternative, the user may request to speak to an operator 296.

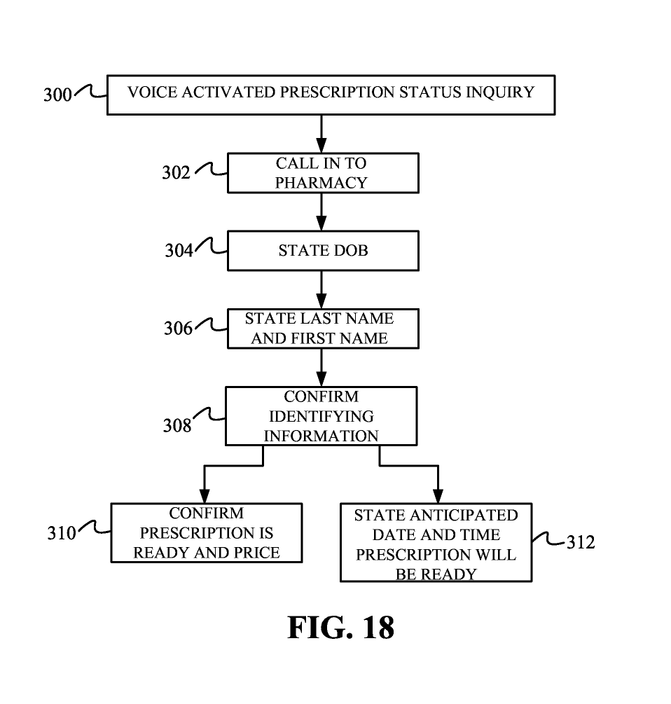

Referring now to FIG. 18, a voice-activated prescription status inquiry process 300 is shown. A patient 324 may call into the pharmacy (i.e. system 10, 10a) to check whether his or her prescription is ready for pickup. Once the patient 324 or user calls into the pharmacy 300, the user may be requested to state his or her date of birth 304. The user may state his or her date of birth. The system 10, 10a may convert the spoken date of birth to a voice profile. The system 10, 10a may then request the user to state his or her last and first name 306. The user may state his or her last and first name at which time the system may convert the spoken last and first name to a voice profile. The system 10, 10a will compare the voice profiles for the date of birth and the last and first names to standard voice profiles of predefined libraries containing the date of birth and the last and first names. The system 10, 10a will speak the date of birth and last and first name at which time the user may confirm 308 his or her identity. Upon confirmation, the system 10, 10a confirms 310 that the prescription is ready and provides the price. If the prescription is not ready, the system 10, 10a may state the anticipated date and time that the prescription will be ready.

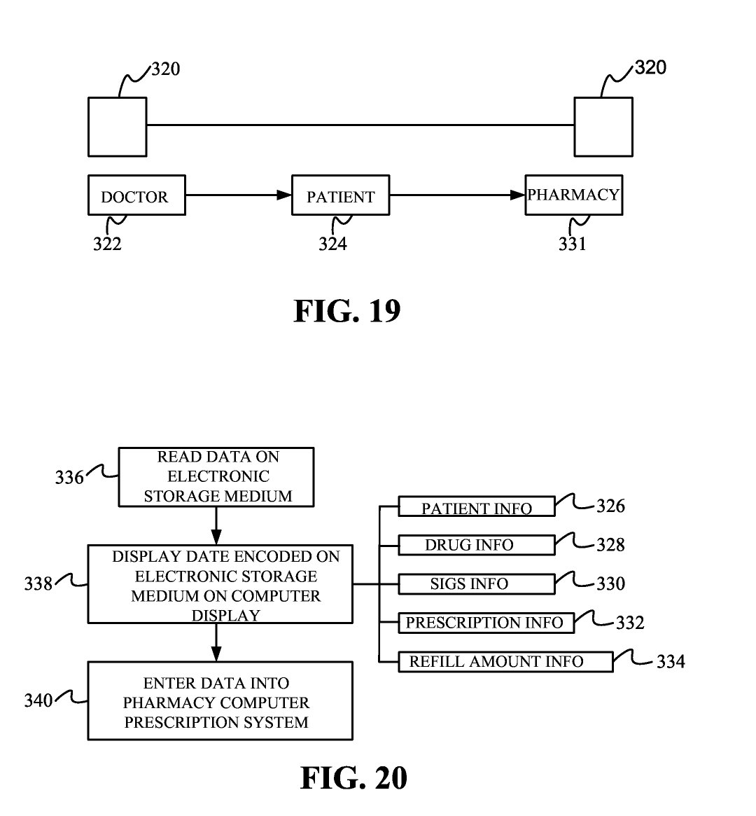

Referring now to FIG. 19, a prescription chip 320 is disclosed. The prescription chip 320 may be provided by a doctor 322 to a patient 324. The prescription chip 320 will have the patient information 326, drug information 328, directions for use information 330, prescriber information 332 including and not limited to contact information for the primary care physician and the refill amount information 334. When the doctor prescribes a pharmaceutical drug, the doctor may embed the prescription chip 320 with information that the pharmacy would search for to fill the prescription. The patient 324 hands the prescription chip to the pharmacy 331 which downloads the information into its system. As such, the pharmacy does not need to search for information but merely needs to upload or read the data on the prescription chip 320. The information or data is displayed 338 on a computer screen 20 and reviewed by the pharmacist 16. The data on the chip 320 is entered 340 into the pharmacy computer prescription system.

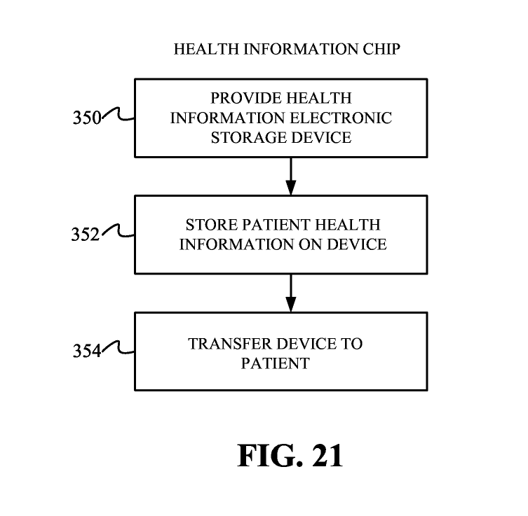

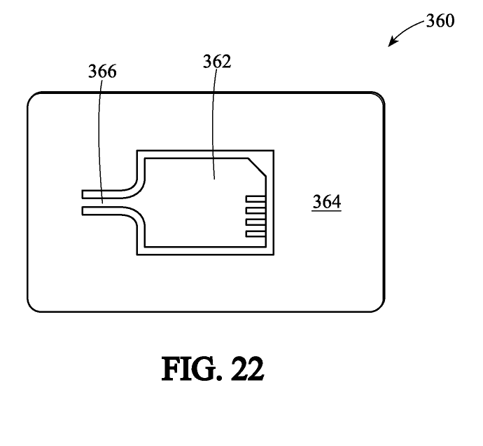

Referring now to FIG. 21, a doctor may provide a health information chip to a patient 324. The health information chip may include all relevant data regarding the patient 324 such as contact information of the patient's primary care physician, allergies, prior medical conditions, past surgeries, prescribed medications, disease states, family history of diseases and basic personal information including but not limited to patient contact information and emergency contact information. When the patient 324 is sick or incapacitated, emergency room personnel may upload the data on the health information chip and such information may be used to treat the patient 324. To this end, the health information may be provided to the doctor 350. The doctor 350 may store the patient's 324 health information on the health information chip 352 then transfer 354 the device to the patient 324, as shown in FIG. 21. The health information chip may also be beneficial for emergency room situations as well as when the patient is traveling out of country.

The health information may be provided in different form factors such as a USB memory stick, a credit card form factor or other form known in the art or developed in the future. Referring now to FIG. 22, the health information chip is shown in the form factor of a credit card 360. The health information chip may be an SD card or other generally flat and compact memory chip. The memory chip 362 is formed on a body 364 having a flat configuration. The body 364 may have the same configuration as a credit card. The memory chip 362 may also have a flat configuration so that the memory chip 362 and the body 364 may fit in the patient's wallet along with his or her credit cards. The overall size and shape of the body 364 may have the same configuration as a credit card. In the event that the patient is incapacitated or needs to transmit information to a doctor at an emergency room or a medical hospital while traveling out of the country, the doctor may access the information electronically embedded on the memory chip 362. In particular, the memory chip 362 is attached to the body with a resilient connecting member 366. The memory chip 362 may be inserted into a memory card reader by bending the resilient connecting member 366 until the memory chip 362 is generally perpendicular to the body 364. The memory chip 362 may be inserted into a memory card reader integrated into a desktop computer or other computing device.

The above description is given by way of example, and not limitation. Given the above disclosure, one skilled in the art could devise variations that are within the scope and spirit of the invention disclosed herein, including various ways of Presenting the data fields to the user. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A pharmaceutical processing system comprising:
a computer with software loaded thereon for performing the following steps of:
receiving a first voice activated command from a user related to a pharmaceutical process;
comparing a first voice profile of the user's first voice activated command to standard voice profiles of a predefined library of pharmaceutical commands related to the pharmaceutical process;
identifying one or more pharmaceutical commands from the library that matches the first voice profile of the user's first voice activated command;
transmitting an audible signal to the user or an electronic signal to a monitor associated with the one or more identified pharmaceutical commands;
receiving confirmation that one of the identified pharmaceutical commands is correct.

2. The system of claim 1 wherein the library of pharmaceutical commands is associated with a frequency and the system serves up a most used pharmaceutical command from a set of identified pharmaceutical commands as an audible or visual signal to the user.

3. The system of claim 2 wherein a set of pharmaceutical commands that matches the voice profile of the user's voice activated command is displayed on the monitor as a list ranked from the most to the least used pharmaceutical command.

4. The system of claim 3 wherein the most used pharmaceutical command is displayed separately from the set of pharmaceutical commands.

5. The system of claim 1 further comprising the step of receiving confirmation from the user that the identified voice activated command is correct.

6. The system of claim 1 further comprising the steps of:
receiving a second voice activated command from the user related to the pharmaceutical process;
after receiving the first and second voice activated commands from the user, comparing the first voice profile of the user's first voice activated command and a second voice profile of the user's second voice activated command to the standard voice profiles of the predefined library of pharmaceutical commands related to the pharmaceutical process; and
identifying one or more pharmaceutical commands from the library that matches the first and second voice profiles of the user's first and second voice activated commands.

7. The system of claim 1 wherein the receiving is accomplished with a clip-on microphone, free standing microphone, monitor microphone, or a headset microphone.

8. The system of claim 1 wherein the steps are used to search for a patient, drug, or prescriber.

9. The system of claim 1 wherein the predefined library of pharmaceutical commands is a database of patient identification information, pharmaceutical information, directions for use information or prescriber information.
